(19) United States
(12) Patent Application Publication
(10) Pub. No.: US 2010/0091986 A1
(43) Pub. Date: Apr. 15, 2010

(54) Information Management System and Encryption System

(75) Inventors: Hironori Wakayama, Saitama (JP); Tadashi Watano, Saitama (JP)

Correspondence Address: COZEN O'CONNOR, P.C., 1900 MARKET STREET, PHILADELPHIA, PA, 19103-3508, US

(73) Assignees: Laputa, Inc., Saitama-shi, Saitama (JP); CANDACS Co., Ltd., Tokyo (JP)

(21) Appl. No.: 12/513,772

(22) PCT Filed: Nov. 6, 2007
(86) PCT No.: PCT/JP2007/071557

§ 371 Date: Dec. 23, 2009

(30) Foreign Application Priority Data
Nov. 10, 2006 (JP) 2006-304677

(51) Int. Cl. H04L 9/28; H04L 9/06

(52) U.S. Cl. 380/44; 380/28

(57) ABSTRACT

A system capable of surely preventing a theft or leak of information which comprises: an information registration destination decision unit deciding registration destinations of information; a distribution unit information generation unit generating distribution unit information pieces; and a plurality of storage grids connectable to the distribution unit information generation unit. The distribution unit information generation unit multiplies original data and divides the multiplied data into a plurality of distribution unit information pieces such that each distribution unit information piece does not include all the elements contained in the original data and the same element occurs repeatedly in the same piece for generation of the distribution unit information pieces, and registers the distribution unit information pieces in the respective storage grids based on the management information about the correlation between the distribution unit information pieces and the storage grids as their registration destinations generated by the information registration destination decision unit.

### TECHNICAL FIELD

This invention relates to a system for reliably preventing theft or leakage of electronic information.

### BACKGROUND ART

A variety of countermeasures have been taken against theft and disruption of confidential information stored in the form of electronic documents. For example, in one of the known methods, access to confidential information is not easily made and also the entry of authentication information is requested for access.

Even if data is accessed or intercepted, the contents are guarded from being read by encrypting the original data before registration or by use of both encryption and authentication.

Patent Document 1: Japanese Unexamined Patent Publication H10-240595

### DISCLOSURE OF THE INVENTION

### Problem to be Solved by the Invention

However, none of the conventionally known systems are capable of perfectly preventing unauthorized access. In addition, in the event unauthorized access is made, even encrypted information can be decrypted. Under the present circumstances, a system is required to prevent leakage of information even if unauthorized access is made.

It is an object of the present invention to provide a system capable of reliably preventing theft or leakage of electronic information.

### Means for Solving the Problem

A first invention is characterized in that an information management system comprises: an information registration destination decision unit deciding registration destinations of information; a distribution unit information generation unit generating distribution unit information pieces; and a plurality of storage grids connectable to the distribution unit information generation unit, the information registration destination decision unit has: a function of determining the storage grids as registration destinations of the respective distribution unit information pieces generated at the distribution unit information generation unit; a function of generating management information about correlation between the distribution unit information pieces and the storage grids corresponding to the registration destinations of the distribution unit information pieces; and a function of notifying the distribution unit information generation unit of the management information generated, and the distribution unit information generation unit has: a function of dividing original data with reference to either a predetermined unit data length or a predetermined dividing number to obtain a vector A=(a₁, a₂, a_{ε}) containing N [symbol] ε elements; a function of multiplying the vector A by a factor of μ to obtain a vector μA=(A₁∥A₂∥ . . . ∥Aμ), wherein A=A₁=A₂= . . . =A_{μ}, on the basis of either multiplying number μεN input to the distribution unit information generation unit or predetermined multiplying number μεN; a function of dividing all the elements of the vector μA thus multiplied into τ number of the distribution unit information pieces on the basis of either τ number of distribution εN applied to the distribution unit information generation unit or predetermined τ number of distribution εN, such that all the elements of the vector A are not included in each distribution unit information piece and the same element of the vector A does not occur in each divided group of the elements twice or more; and a function of registering the distribution unit information pieces to the corresponding storage girds on the basis of the management information defining the correlation between the distribution unit information pieces and the storage grids received from the information registration destination decision unit.

The ε number of elements, the multiplying number μ and the τ number of distributions are natural numbers, and it is necessary to set the τnumber of distributions to 2 or higher.

The information registration destination decision unit and the distribution unit information generation unit may be provided in the same device, or alternatively may be provided in separate devices connected to each other through a communication line.

Each of the storage grids and the distribution unit information generation unit may be configured to be connectable to each other through communication means, or alternatively, to be directly connectable to each other. In either case, for the purpose of making effective use of the distribution effect, it is desirable that the storage grids and the distribution unit information generation unit are respectively installed in two hardware devices located at a physical distance from each other as much as possible, and managed independently of each other.

The sign “∥” means the combining of vectors. For example, (A₁∥A₂) means a sequence vector in which a vector A₁ and a vector A₂ are arranged side by side and combined together without a change in array.

A second invention, which is based on the first invention, is characterized in that the information registration destination decision unit has a function of determining a combination of ε number of elements, multiplying number μ and τ number of distributions which fulfills either condition 1 or condition 2; and a function of outputting the combination of ε number of elements and multiplying number μ thus determined, and in the condition 1 when a greatest common divisor q of the τ number of distributions and the ε number of elements is one, the relation “the multiplying number μ<τ number of distributions” is established, and in the condition 2 when a greatest common divisor q of the τ number of distributions and the ε number of elements is not one, the τ number of distributions and the ε number of elements are indivisible by each other and also the relation “the multiplying number μ≦(τ number of distributions/greatest common divisor q)” is established.

A third invention, which is based on the first or second invention, is characterized in that the distribution unit information generation unit has a function of repeating, in either a column direction or a row direction, a process of arranging all the elements of the vector obtained by multiplying original data by the multiplying number μ in element order either in the row direction or the column direction, to form a matrix with the number of either columns or rows in accordance with the τ number of distributions and a required number of either rows or columns, and a function of defining either each of the columns or each of the rows of the matrix as a single distribution unit information piece.

A fourth invention, which is based on the first to third inventions, is characterized in that the information management system further comprises either the information registration destination decision unit or a separate management information storing unit from the information registration destination decision unit for storing the management information; and an information restoration unit restoring the distribution unit information pieces to the original data, and the information restoration unit has a function of collecting the distribution unit information pieces from the respective storage grids, a function of acquiring the management information, and a function of arranging the collected distribution unit information pieces on the basis of an arrangement order determined from the management information.

When the information restoration unit collects the distribution unit information pieces from the storage grids, the information restoration unit itself may access the information stored in each storage grid for information collection, or in some cases each storage grid may transmit the required information to the information restoration unit based on the instruction from the information registration destination decision unit or the management information storing unit.

A fifth invention, which is based on the first to fourth inventions is characterized in that the information management system comprises an encryption unit interconnected to the distribution unit information generation unit, and the encryption unit has a function of encrypting original data, and the distribution unit information generation unit has a function of multiplying data encrypted by the encryption unit with multiplying number μ.

An encryption system according to a sixth invention is characterized by comprising a plaintext input unit; an encryption unit; and a pseudo-random number generation unit, and in that the pseudo-random number generation unit generates pseudo-random numbers by performing: a function of dividing seed for generating pseudo-random numbers into elements in units of predetermined information amount; a function of generating a matrix using the elements as row headers and column headers; a function of defining a specific cell in the matrix as a first cell and assigning, to the first cell, a result of modulo n arithmetic, where n is a predetermined value other than zero, performed on a result of addition of values of the row header and the column header relating to the first cell together; a function of, for each of the cells other than the first cell in the matrix, adding at least three or more values of the values assigned to the corresponding row and column in order to form multiple Markov process, then performing modulo n arithmetic, where n is a value other than zero, and then assigning a result of the modulo n arithmetic to the cell; and a function of rearranging the values assigned to the respective cells in either column order or row order on either column-by-column basis or row-by-row basis, and also the pseudo-random number generation unit generates pseudo-random numbers by performing: a function of outputting the pseudo-random numbers to the encryption unit when the pseudo-random numbers has a data length greater than the data length of the plaintext, and of generating a matrix by use of either part of or all the elements of the generated pseudo-random numbers as either row headers or column headers, or both of the row headers and the column headers when the generated pseudo-random numbers has a data length less than the data length of the plaintext; a function of defining a specific cell in the matrix as a first cell and assigning, to the first cell, a result of modulo n arithmetic, where n is a predetermined value other than zero, performed on a result of addition of values of the row header and the column header relating to the first cell together; a function of, for each of the cells other than the first cell in the matrix, adding at least three or more values of the values assigned to the corresponding row and column together, then performing modulo n arithmetic on the added value, and then assigning a result of the modulo n arithmetic to the cell; and a function of rearranging the values assigned to the respective cells in either column order or row order on either column-by-column basis or row-by-row basis, and also the pseudo-random number generation unit repeatedly performs the pseudo-random number generating function until the generated pseudo exceeds the data length of the plaintext, and then when the pseudo-random number greater than the data length of the plaintext is generated, this pseudo-random numbers are output to the encryption unit, and the encryption unit uses a vector of the pseudo-random numbers supplied from the pseudo-random number generation unit as an encryption key to calculate a direct sum of the plaintext and the encryption key for encryption.

The multiple Markov process corresponds to discrete time or continuous time Markov chain.

An encryption system according to a seventh invention is characterized by comprising a plaintext input unit; an encryption unit; and a pseudo-random number generation unit, and in that the pseudo-random number generation unit has a function of using variable seed corresponding to each plaintext received from the plaintext input unit to generate variable pseudo-random numbers having a data length greater than the data length of the plaintext, and the encryption unit has a function of calculating a direct sum of a vector of the generated variable pseudo-random numbers and a predetermined fixed vector to generate an encryption key, and a function of calculating a direct sum of the generated encryption key and the plaintext for encryption.

An encryption system according to an eighth invention is characterized by comprising a plaintext input unit; an encryption unit; and a pseudo-random number generation unit, and in that the pseudo-random number generation unit has a function of using variable seed determined for each plaintext so as to correspond to the plaintext received from the plaintext input unit to generate variable pseudo-random numbers having a data length greater than the data length of the plaintext, and a function of using a predetermined fixed seed to generate variable pseudo-random numbers having a data length greater than the data length of the plaintext, and the encryption unit has a function of calculating a direct sum of vectors of the two sets of the variable pseudo-random numbers thus generated to generate an encryption key, and a function of calculating a direct sum of the generated encryption key and the plaintext for encryption.

The encryption system according to a ninth invention, based on the seventh, eighth invention, is characterized in that the pseudo-random number generation unit has a function of calculating a direct sum of a variable vector varied to correspond to a plaintext received from the plain text input unit and a predetermined fixed vector to generate the variable seed.

A tenth invention, based on the seventh to ninth inventions, is characterized in that the pseudo-random number generation unit generates pseudo-random numbers by performing: a function of dividing seed for generating pseudo-random numbers into elements in units of predetermined information amount; a function of generating a calculation table (hereinafter referred to as “matrix”) using the elements as row headers and column headers; a function of defining a specific cell in the matrix as a first cell and assigning, to the first cell, a result of modulo n arithmetic, where n is a predetermined value other than zero, performed on a result of addition of values of the row header and the column header corresponding to the first cell together; a function of, for each of the cells other than the first cell in the matrix, adding at least three or more values of the values assigned to the corresponding row and column together in order to form multiple Markov process, then performing modulo n arithmetic, where n is a value other than zero, and then assigning a result of the modulo n arithmetic to the cell; and a function of rearranging the values assigned to the respective cells in either column order or row order on either column-by-column basis or row-by-row basis, and also the pseudo-random number generation unit generates pseudo-random numbers by performing: a function of outputting the pseudo-random numbers to the encryption unit when the pseudo-random numbers has a data length greater than the data length of the plaintext, and of generating a matrix by use of either part of or all the elements of the generated pseudo-random numbers as either row headers or column headers, or both of the row headers and the column headers when the pseudo-random numbers has a data length less than the data length of the plaintext; a function of defining a specific cell in the matrix as a first cell and assigning to the first cell a result of modulo n arithmetic, where n is a predetermined value other than zero, performed on a result of addition of values of the row header and the column header corresponding to the first cell together; a function of, for each of the cells other than the first cell in the matrix, adding at least three values or more of values assigned to the corresponding row and column together, then performing the modulo n arithmetic on the added value, and then assigning a result of the modulo n arithmetic to the cell; and a function of rearranging the values assigned to the respective cells in either column order or row order on either column-by-column basis or row-by-row basis, and the pseudo-random number generation unit repeatedly performs the pseudo-random number generating function until the generated pseudo-random numbers exceeds the data length of the plaintext, and then outputs the pseudo-random numbers to the encryption unit when the pseudo-random number greater than the data length of the plaintext is generated.

In the foregoing sixth to tenth inventions, the plaintext means data before being encrypted. For example, if original data to be safely stored is encrypted as it is, the original data is referred to as the plaintext, but if original data to be safely stored is encrypted after being subjected to any processing such as multiplying or dividing, the data after subjected to the processing is referred to as the plaintext. In addition, the aforementioned plaintext includes image data, sound data and the like as well as text data.

In addition, “variable” included in the aforementioned “variable pseudo-random numbers”, the aforementioned “variable seed” and the aforementioned “variable vector” is herein used in the sense that the pseudo-random numbers, the seed and the vector can be set, determined or generated for each plaintext, and “fixed” is used in the sense that the pseudo-random numbers, the seed and the vector are fixedly set without a change irrespective of the plaintext.

Specifically, the variable vector is a vector determined for each plaintext, and the variable seed is seed for pseudo-random numbers and is determined for each plaintext.

The variable pseudo-random numbers are pseudo-random numbers generated for each plaintext every time the encryption process is carried out. Accordingly, in addition to the pseudo-random numbers generated using the aforementioned variable seed, pseudo-random numbers generated using a previously set fixed vector as seed are varied in value in accordance with a data length, thus being included in the group of the “variable pseudo-random numbers”.

The fixed vector means a vector of predetermined fixed values.

### ADVANTAGEOUS EFFECTS OF THE INVENTION

According to the first invention, each of the distribution unit information pieces does not contain all the elements of sequence vector generated on the basis of the original data, and contain different elements of the elements of the vector so as not to allow the same element to occur twice or more therein. As a result, it is possible to prevent the information contents of the original data from being stolen by separately registering or transmitting/receiving the data in distribution unit information pieces to the respective storage grids.

In addition, each storage grid holds part or discrete elements of the elements of the sequence vector derived from the original data. In consequence, even if the information is stolen in units of distribution unit information pieces, it is absolutely impossible to reconstruct the original data from the stolen information alone. Because all the elements are not orderly arranged and the information of the original data is partially lost, even if the elements of the sequent vector are rearranged, the original data cannot be reproduced. That is, the security in terms of the amount of information is ensured because of the limits provided by each of the distribution unit information pieces.

In addition, even if the information stored in all the storage grids, unless the trying-out of various combinations of the distributed elements is made, the information cannot be stolen without stealing the management information about the correlation between the storage grids and the distribution unit information pieces. For predicting the arrangement of the distributed and registered distribution unit information pieces without the management information, it is required to try out various combinations of arrangements. When the number of storage grids is σ, the total number of combinations with consideration given to the arrangement order of the distribution unit information pieces results in _{σP}_{τ}, and the entropy is log₂(_{σ}P_{τ}). Thus, an increase of any one or both of the number of storage grids mounted in the system and τ number of distribution causes a sharp increase in the amount of calculations required for trying the arrangement.

On the other hand, it has been regarded that when the equivalent security exceeds 80 bits (80-bit security), the security in terms of the amount of calculation is provided in the current calculation power of computers. For this reason, it can be thought that the selection of σ and τ such that 80≦log₂(σP_{τ}) is obtained makes it possible to assure the security in terms of the amount of calculation. For example, when σ=τ, log₂(₂₄P₂₄)<80<log₂(₂₅P₂₅) is established. From this, if the τ number of distributions is set at 25 or higher, the security in terms of the amount of calculation can be provided. For reference, the equivalent security is a value for rating an encryption scheme against a worldwide standard (a measure of the security of an encryption algorithm), which is equal to a value of entropy a symmetric key encryption scheme, that is, a common key encryption scheme. The guideline (SP800-57 and the like) of National Institute of Standards and Technology (NIST) has made the recommendation that 80-bit of security strength should be provided until the end of 2010, and then 112 bits of security strength should be provided. In the above-mentioned example, since log₂(₃₀P₃₀)<112<log₂(₃₁P₃₁) is established, this standard will be easily overcome simply by setting τ≧31.

In addition, because the vector of the original data is multiplied by a multiplying number μ, if information, that is, the distribution unit information pieces, stored in the (μ−1) storage grids is damaged, all the elements are stored in the remainder of the storage grids, so that the original data can be reproduced from the information stored in the remainder of the storage grids. In consequence, important information can be protected.

According to the second invention, although it is required to fulfill the condition that each of the distribution unit information pieces contains only part of the elements contained in the vector A of the original data and does not contain the same element occurring twice or more therein, the condition can be fulfilled by automatically deciding a combination of ε number of elements of the vector A, multiplying number μ, and τ number of distributions.

According to the third invention, since the elements can be easily arranged such that the same element does not occur twice or more in each distribution unit information piece, this facilitate the division of the elements into groups such that each of the distribution unit information pieces contains only part of the elements of the vector A and the same element of the vector A does not occur twice or more in each distribution unit information piece.

According to the fourth invention, it is possible to collect and easily restore the distribution unit information pieces, which have been distributed and registered, to the original data.

According to the fifth invention, since the original data is encrypted and then multiplied and then distribution unit data is generated, even if, for example, the management information is stolen and the arrangement of distribution unit information pieces leaks out, the restoring of the original data is made difficult.

With the encryption system according to the sixth to tenth inventions, encryption is achieved by use of a vector of pseudo-random numbers of which the regularity cannot easily predicated. This makes it possible that the encrypted text is not easily decrypted in terms of the amount of calculations or information theory.

In addition, in response to input of plaintext, the pseudo-random number generation unit automatically generates pseudo-random number for each plaintext, and then the generated pseudo-random number is used to generate an encryption key. Because of this, it is possible to variably generate the encryption key in accordance with plaintext. If the same encryption key is used in the encryption process of different plaintexts, the encryption key may be possibly predicted by comparing the encrypted texts encrypted by the same key. However, changing encryption keys for each plaintext make it impossible to predict the encryption key, so that the cipher is not cracked. The encryption key is also prevented from being estimated by means of use of a different encryption key for each plaintext.

Since such a cipher cannot be deciphered to produce the plaintext without the encryption key, leakage of information can be prevented.

According to the sixth invention, since the pseudo-random numbers having a data length greater than the data length of the plaintext, a virtually unbreakable encryption can be effectively achieved.

According to the seventh, the eighth invention, the use of the variable pseudo-random numbers generated by the pseudo-random number generation unit makes it possible to generate an encryption key appropriate for each plaintext.

Since the encryption key is generated by use of the sum of the variable pseudo-random number and either the fixed vector or the variable vector which is generated by use of the fixed vector as seed, if a fixed pseudo-random numbers or fixed seed is previously set in the receiving side, when the cipher is transmitted, the transmission of the variable seed alone allows the receiving side receiving the cipher to generate an encryption key.

In this manner, if the encryption key can be also generated in the decoding side, there is no need to transmit the encryption key, reading in no risk of theft of the encryption key on the communication path. Even if the variable seed is stolen on the communication path, the encryption key cannot easily generated without stealing the predetermined fixed pseudo-random numbers or fixed seed.

In particular, according to the eighth invention, the pseudo-random number generation unit is configured to calculate a direct sum of the variable pseudo-random numbers generated using the variable seed and the vector of the pseudo-random numbers generated using the fixed seed for the generation of the encryption key. Thus, as compared with the case of setting a fixed vector having a data length in accordance with the data length of the plaintext, the load of storing data can be reduced. In addition, a significant reduction in transmission costs can be achieved because the sending of the variable seed alone, instead of the encryption key, is required for the communication of the cipher generated according to the present invention.

Also, in the ninth invention, the variable seed is generated by use of a sum of a variable vector and a fixed vector. This makes it more difficult to see through the variable seed. As a result, the security of encrypted text can be further increased.

According to the tenth invention, since multiple Markov process is employed for calculation for generating pseudo-random numbers, pseudo-random numbers without periodicity and with initial-value sensitivity and homogeneity can be generated, thus making it possible to provide encryption with extremely high security.

### BRIEF DESCRIPTION OF THE DRAWINGS

FIG. 1 is a block diagram of an information management system.

FIG. 2 is a diagram showing an example of original data.

FIG. 3 is a diagram showing an example of a multiplied vector.

FIG. 4 is a diagram illustrating a matrix for generating distribution unit information pieces.

FIG. 5 is a diagram illustrating individually the distribution unit information pieces.

FIG. 6 is an example of a registration destination allocation table showing registration destinations for the distribution unit information pieces.

FIG. 7 is a diagram illustrating the distribution unit information pieces registered to storage grids.

FIG. 8 is a block diagram of an encryption system.

FIG. 9 is an equation representing an example of encryption.

FIG. 10 is a schematic diagram illustrating the data flow in an encryption system.

FIG. 11 is an equation representing the configuration of an encryption key.

FIG. 12 is an equation for decryption in the encryption system shown in FIG. 8.

FIG. 13 is a matrix illustrating a procedure for generating pseudo-random numbers.

FIG. 14 is a matrix illustrating a procedure for generating pseudo-random numbers.

FIG. 15 is a schematic diagram illustrating the data flow in another encryption system.

FIG. 16 is an equation expressing the configuration of an encryption key in the encryption system illustrated in FIG. 15.

FIG. 17 is an equation for decryption in the encryption system illustrated in FIG. 15.

### BEST MODE FOR CARRYING OUT THE INVENTION

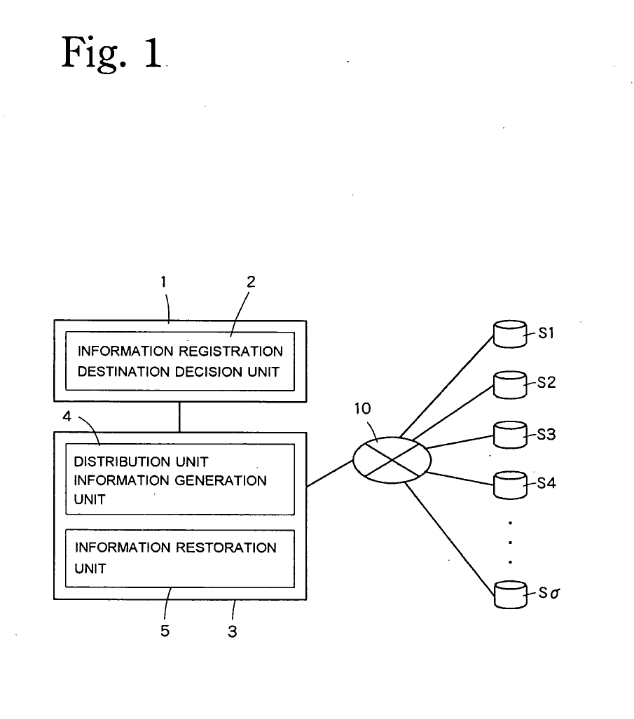

Embodiments of an information management system according to the present invention are described with reference to FIG. 1 to FIG. 7.

As illustrated in FIG. 1, the system comprises a management server 1 having an information registration destination decision unit 2, a user terminal 3 having a distribution unit information generation unit 4 and an information restoration unit 5, and a plurality of storage grids S1, S2, S3, S4, . . . , and Sσ which correspond to storage grids of the present invention.

The storage grids S1, S2, S3, S4, . . . , and Sσ function in a similar manner to each other in response to access from the user terminal 3. Therefore, in the following description, when there is no need to describe the individual storage grids as distinct from one another, the reference letter S is representatively used for all the storage grids. When there is a need to individually describe the storage grids, the storage grids are respectively described by use of the reference letter S with reference numbers such as 51, S2, S3, S4, . . . , Sσ. The system comprises σ number of storage grids.

In the system of the present invention, the user terminal 3 is a user-used terminal storing information which is desired to be safely registered, that is, the original data in the present invention. The user terminal 3 is connectable to the management server 1 and a plurality of storage grids S. The distribution unit information generation unit 4 and the information restoration unit 5 of the user terminal 3 are independently able to access the information registration destination decision unit 2 of the management server 1 and each of the storage grids S.

Note that the storage grids of the present invention are not limited to servers connected to communication means 10 as described above. Any type of data storage means can be used as the storage grid as long as it is connectable to the user terminal 3. On the other hand, the management server 1 is configured to be incapable of obtaining user entered data from each of the storage grids S.

The distribution unit information generation unit 4 of the user terminal 3 has the function of dividing information into a plurality of units to generate distribution unit information pieces, and the function of separately storing the generated distribution unit information pieces in the storage grids S, which will be described in detail later.

The information restoration unit 5 of the user terminal 3 has the function of collecting the distribution unit information pieces which have been generated by the distribution unit information generation unit 4 and then distributed and registered in the storage grids S, and restoring the collected distribution unit information pieces to the original data.

Then, the information registration destination decision unit 2 of the management server 1 has the function of deciding the registration destinations of a plurality of distribution unit information pieces generated by the distribution unit information generation unit 4. Specifically, the information registration destination decision unit 2 decides which distribution unit information piece should be registered in which storage grid S, and then notifies the correlation between each distribution unit information piece and each storage grid S to the user terminal 3 in response to access from the user terminal 3.

In this case, the information registration destination decision unit 2 correlates the registration destinations with information by which distribution units of the information can be identified, such as unit identifying codes, the unit names or the like of the distribution unit information pieces rather than the specific contents of the distribution unit information pieces.

For example, the correlation is defined such that, when the distribution unit information pieces are respectively numbered and grouped into 1^{st} to τ^{th} groups, the first group is assigned to the storage grid S1 and the second group is assigned to the storage grid S2.

The correlation between the groups of the distribution unit information pieces and the storage grids S is randomly decided by the information registration destination decision unit 2 whenever the distribution unit information pieces are generated. The random decision of the registration destinations of the distribution unit information pieces means that the storage grids are selected from the plurality of storage grids S as registration destinations of the distribution unit information pieces in accordance with the number of distribution unit information pieces generated by the distribution unit information generation unit 4, and also the distribution unit information pieces are randomly correlated with the respective storage grids.

Since the aforementioned correlation between the distribution unit information pieces and the registration destinations directly corresponds to the order of arranging the distribution unit information pieces, the random decision of the correlation makes it difficult to predict the arrangement order in term of the amount of calculation required, thus reliably protecting information.

Such information, decided as described above for defining the correlation between the distribution unit information pieces and the storage grids, is the management information of the present invention.

The following is a description of an example of how the system safely stores original data produced in the user terminal 3 and retrieves it.

First, a description will be given of the procedure by which the distribution unit information generation unit 4 produces distribution unit information pieces from original data produced in the user terminal 3. The following procedure for producing distribution unit information pieces is automatically carried out in accordance with a program previously installed into the distribution unit information generation unit 4 of the user terminal 3.

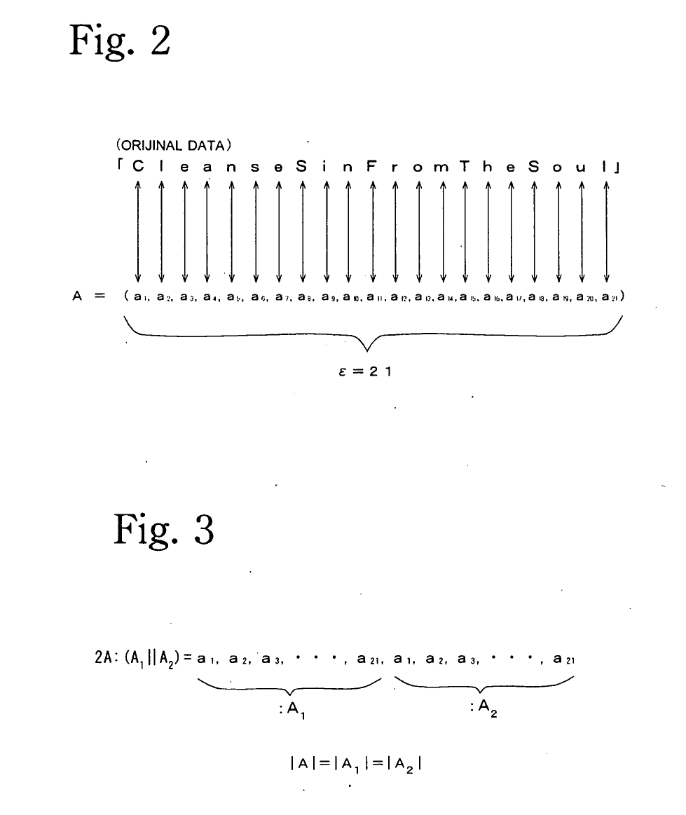

The example assumes that the original data is the 42 bytes of data indicating “SaMiDaReWoATuMeTeHaYaSiMoGaMiGaWaBaSiYoU” shown in FIG. 2.

First, the distribution unit information generation unit 4 calculates ε number of elements with the assumption that the aforementioned original data is a vector A containing elements having a predetermined unit data length. The unit data length is predetermined for the distribution unit information generation unit 4 to produce distribution unit information pieces. The unit data length may be of any size and may be changed in accordance with the original data. The embodiment defines the unit data length as “2 bytes” required for each character in the original data.

In this connection, as illustrated in FIG. 2, a vector A containing elements having the above-mentioned unit data length is the 42-byte original data delimited in unit data length for each character, and is represented as vector A=(a1, a2, a3, . . . , a21) which contains ε number of elements which is equal to 21.

For reference, the unit data length may be set into the distribution unit information generation unit 4 by manual input by an operator, or alternatively may be automatically decided by the distribution unit information generation unit 4. Alternatively, another apparatus may be used to decide the unit data length, and then the unit data length may be input to the distribution unit information generation unit 4 of the user terminal 3.

The data length of the original data, the unit data length and ε number of elements of vector A have the relationship of (data length of original data)/(unit data length)=(E number of elements). For this reason, the distribution unit information generation unit 4 may determine the data length of the original data and decide a unit data length in accordance with the determined data length in order to obtain the required ε number of elements.

Instead of the setting of the unit data length, ε number of elements may be previously set, and then the distribution unit information generation unit 4 may calculate the unit data length on the basis of the ε number of elements set.

Next, the distribution unit information generation unit 4 multiplies the vector A by a multiplying number μ. The multiplying number μ may be previously set in the distribution unit information generation unit 4, or alternatively may be entered by the user as occasion requires. Or again, a value decided by another apparatus may be input.

In this example, with the assumption that the multiplying number μ is equal to 2, the vector A is duplexed to produce a vector 2A. Assuming A=A1=A2, the vector 2A is represented as {A1=∥A2}. In this case, the sign “∥” means the combining of vectors, and the vector 2A is constructed by repeating the elements “a₁, a₂, a₃, . . . , a₂₁” of the vector A twice as illustrated in FIG. 3. Accordingly, in the embodiment, the multiplying number μ of the present invention is 2, and the vector 2A contains 42 elements.

In this way, after the vector A has been multiplied, all the elements are divided among τ number of distributions of the distribution unit information pieces. For reference, the τ number of distributions may be previously set in the distribution unit information generation unit 4, or alternatively may be entered by the user as occasion requires. Or again, a value decided by another apparatus may be input. Note that the following description is given of the case of producing six distribution unit information pieces, assuming that the z number of distributions=6. The 42 elements are grouped into six distribution unit information pieces such that the 7 elements are contained in each distribution unit information piece, in which case all the elements of the vector A are not contained in any one distribution unit information piece and the same element does not occur twice or more in the same piece.

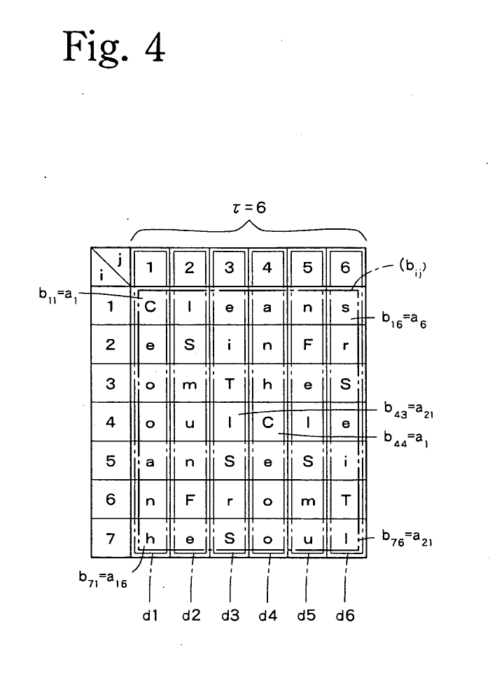

For the purpose of dividing the 42 elements into 6 groups of 7 elements such that all the elements of the vector A are not included in any one distribution unit information piece and the same element does not occur twice or more in the same piece, all the elements are arranged in row/column order in the respective cells of a matrix (bᵢⱼ) with 7 rows and 6 columns as illustrated in FIG. 4, for example.

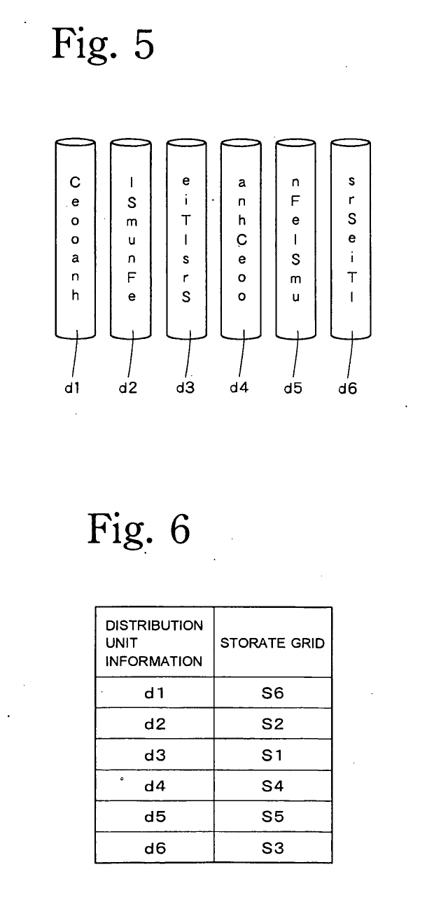

Specifically, the aforementioned elements a₁, a₂, a₃, . . . , are arranged in order in the row direction starting from b₁₁ of the matrix (bᵢⱼ). Then, after the element a₆ is placed in b₁₆, the elements a₇, a₈, . . . are arranged in the row direction starting from the cell b₂₁ in the first column and the second row. In this manner, the arrangement in the row direction is repeated until the element a₂₁ is placed in the last cell b₇₆ in the seventh row and the sixth column until all the elements are assigned. As a result, one set of all the elements of the vector A are completely arranged in the cells b₁₁ to b₄₃, and another set of all the elements of the vector A are again arranged in the cells b₄₄ to b₇₆. Then, the columns of the matrix (bᵢⱼ) consisting of those elements respectively form distribution unit information pieces d1, d2, d3, d4, d5 and d6. In other words, the distribution unit information generation unit 4 produces six distribution unit information pieces d1, d2, d3, d4, d5 and d6 as shown in FIG. 5.

Each of distribution unit information pieces d1, d2, d3, d4, d5 and d6 produced as described above is made up of the seven elements, and none of the distribution unit information pieces d1, d2, d3, d4, d5 and d6 do contain the same element twice or more.

The methods for dividing all the elements produced by multiplying the vector A among τ number of distributions of the distribution unit information pieces are not limited to the aforementioned method, but if the elements are arranged in the same order as that in the vector A in the row direction of the matrix (bij), this makes it possible to facilitate the generation of distribution unit information pieces so that no one unit contains all the elements of the vector A and contains the same element occurring twice or more therein.

Any method can be employed for determining the multiplying number μ and τ number of distributions, but there is a necessity to determine the multiplying number μ and τ number of distributions in such a manner as to fulfill the conditions “no distribution unit information piece contains all the elements of a vector A and contains the same element twice or more”. For fulfilling the conditions, the multiplying number μ, τ number of distributions, and ε number of elements of the vector A are determined in such a manner as to fulfill either of the following conditions 1 or 2.

In condition 1, when the greatest common divisor q of τ number of distributions and ε number of elements is one, the relation “the multiplying number μ<τ number of distributions” is established. In condition 2, when the greatest common divisor q of τ number of distributions and ε number of elements is not one, the τ number of distributions and ε number of elements cannot be divisible by each other and also the relation “the multiplying number μ≦(τ number of distributions/greatest common divisor q)” is established.

A multiplying number μ, τ number of distributions, and ε number of elements that can fulfill the conditions 1 or 2 must be employed.

In the embodiment, the information registration destination decision unit 2 of the management server 1 decides the multiplying number μ and τ number of distributions which fulfill the aforementioned conditions.

Specifically, upon the input of the original data to the user terminal 3, the distribution unit information generation unit 4 produces a vector A through the aforementioned procedure. At this stage, ε number of elements of the vector A is calculated on the basis of the data length of the original data and the unit data length. After the distribution unit information generation unit 4 has calculated ε number of elements, the user terminal 3 transmits the ε number of elements to the management server 1. The information registration destination decision unit 2 of the management server 1 that receives the ε number of elements calculates varying multiplying numbers and varying τ numbers of distributions in accordance with the ε number of elements. Note that the upper limit for the τ number of distributions is the σ number of storage grids S of the system.

In actuality, in some cases, a plurality of combinations of the multiplying numbers μ and the τ numbers of distributions, which fulfill either of the condition 1 or 2, are calculated in accordance with the ε number of elements. Therefore, the information registration destination decision unit 2 calculates the available combinations and then transmits them to the user terminal 3 for display, thus allowing the user to select one of the combinations.

When the user selects any combination from the combinations of the multiplying numbers μ and the numbers τ of distributions, the selection signal is applied to set the corresponding multiplying number μ and the corresponding τ number of distributions in the distribution unit information generation unit 4, and the management server 1 is notified of the set multiplying number μ so set which is then stored, together with management information, in the information registration destination decision unit 2. That is, in the embodiment, the information registration destination decision unit 2 has the function of storing management information, but another management information storing unit besides the information registration destination decision unit 2 may be provide.

Also, the information registration destination decision unit 2 creates a registration-destination allocation table for specifying the correlation between the distribution unit information pieces and the registration destinations, and then transmits the table to the distribution unit information generation unit 4. Then, the information registration destination decision unit 2 correlates the information for identifying the original data with the registration-destination allocation table and stores it as management information.

For reference, the registration-destination allocation table includes information about the arrangement order of the distribution unit information pieces.

The distribution unit information generation unit 4 generates distribution unit information pieces d1, d2, d3, d4, d5 and d6 as shown in FIG. 5 on the basis of the multiplying number μ and τ number of distributions decided as described above, using the matrix as shown in FIG. 4. At this stage, the ε number of elements of the vector A=21, the multiplying number μ=2, and the τ number of distributions=6 fulfill condition 2, so that no one piece of the distribution unit information pieces d1, d2, d3, . . . includes all the elements of the vector A or includes the same element twice or more.

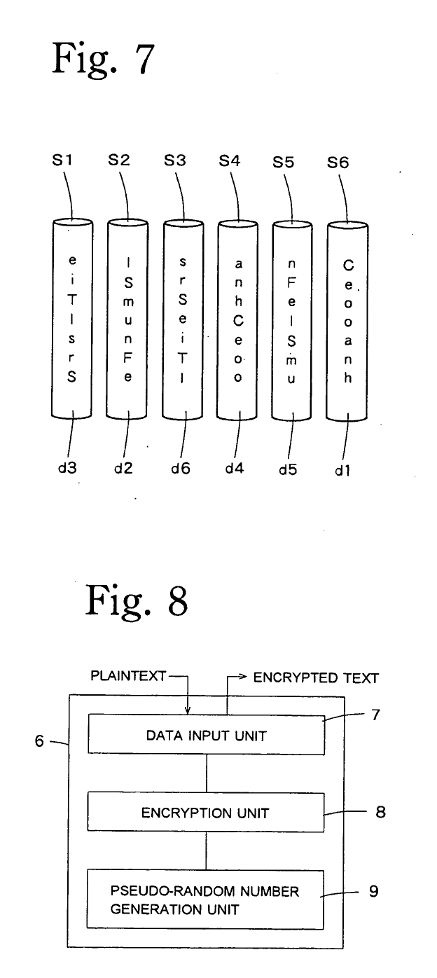

After generation of the distribution unit information pieces, the distribution unit information generation unit 4 registers each of the distribution unit information pieces on the basis of the registration-destination allocation table transmitted from the information registration destination decision unit 2 of the management server 1. For example, when the information registration destination decision unit 2 transmits the registration-destination allocation table showing the distribution unit information pieces and the registration-destination storage grids S illustrated in FIG. 6, the distribution unit information generation unit 4 registers the distribution unit information pieces in the respective storage grids S as shown in FIG. 7. Specifically, the distribution unit information pieces d3, d2, d6, d4, d5 and d1, each of which contains 7 elements, are respectively registered in the storage grids S1, S2, S3, S4, S5 and S6.

An arbitrary authentication system aside from the information management system is used to allow only authorized person/persons to access the distribution unit information pieces registered in the respective storage grids S. Nevertheless, there is the possibility of stealing the distribution unit information piece by unauthorized access. However, in this system, the vector A corresponding to the original data is distributed and registered, so that even if the distribution unit information piece is stolen from any storage grid S, the stolen distribution unit information piece includes only a part of the vector A. For this reason, the original data cannot be understood simply by stealing information only one storage grid S. That is, the security in terms of the amount of information is ensured because of the limits provided by each of storage grids S or each of the distribution unit information pieces.

Even if the security of the plurality of storage grids S is broken and all the distribution unit information pieces can be stolen, it is impossible to read the original data unless the arrangement of the distribution unit information pieces is understood.

That is, the registration of the information distributed among the plurality of the storage grids S as described above makes it possible to provide the security of the information even if the distribution unit information piece registered in each storage grid S is accessed.

For predicting the arrangement of the distributed and registered distribution unit information pieces without the aforementioned management information, the trying out of arrangement combinations is required. However, the number of all combinations taking the arrangement order of the distribution unit information pieces into account is σPτ. This means that an increase in one or both the σ number of storage grids of the system and the τ number of distributions results in a sharp increase in the amount of calculation required for trying arrangements.

On the other hand, it is said that when the entropy exceeds 80, the security in terms of the amount of calculation required is provided in the current calculation power of computers. Accordingly, by selecting σ and τ such that 2⁸⁰≦σPτ is obtained, the security in terms of the amount of calculation required can be assured.

For example, when the σ number of storage grids is equal to the τ number of distributions, ₂₄P₂₄<2⁸⁰<₂₅P₂₅ is established. That is, if the σ number of storage girds and the τ number of distributions are determined to be equal to or higher than 25, the entropy exceeds 80, thus providing security in terms of the amount of calculation required.

When the entropy is 80, 2⁸⁰<₁₀₀₀P₈ results, so that when the σ number of storage grids is 1000, the τ number of distributions becomes 8, thus providing security in terms of the amount of calculation required.

Next, the procedure when the user who registers the aforementioned information restores the original data will be described.

The user instructs the information restoration unit 5 of the user terminal 3 to restore specified information, whereupon the information restoration unit 5 communicates with the information registration designation decision unit 2 of the management server 1 to designate information for specifying the original data and inquire a registration-destination allocation table showing the registration destinations and the arrangement order of the information. For example, the management server 1 transmits a list of user-readable files after the user has been identified through the user authentication, and then the user specifies a file from the list, whereby the instructions of the information restoration unit 5 are executed.

The information registration destination decision unit 2 transmits the registration-destination allocation table (see FIG. 6) which is stored in correlation with the information for specifying the designated original data, and a multiplying number μ to the information restoration unit 5.

In this case, since the allocation table illustrated in FIG. 6 is transmitted to the information restoration unit 5, the information restoration unit 5 collects the distribution unit information pieces from each of the storage grids S1 to S6 in accordance with the allocation table. At this stage, the management server transmits destination information and file specifying information together with a session ID to the grid. Upon reception of this information, the grid transmits the corresponding file to the user. The user-side system may be configured to confirm the validity of the file received by means of the session ID. Then, the six distribution unit information pieces so collected are re-arranged in the order d1 to d6 to create the matrix (bᵢⱼ) illustrated in FIG. 4. The elements in the matrix (bᵢⱼ) are arranged one after the other in order from b₁₁ in the row direction, resulting in {A1∥A2} in which the vector A occurs twice. The two vectors are connected as they are, resulting in information indicating the original data repeated twice. That is, “SaMiDaReWoATuMeTeHaYaSi . . . BaSiYoUSaMiDaReWo . . . BaShou” results.

Information indicating the original data repeated twice is produced by rearranging the distribution unit information pieces. This is because the distribution unit information generation unit 4 determines the multiplying number μ=2 for multiplying the vector A. The information restoration unit 5 divides the information produced by the multiplying number μ which is received from the information registration destination decision unit 2, to restore the vector 2A to the vector A, that is, the original data.

In this regard, the management information may include the data length of the original data and information for specifying registration destinations including elements of the original data such that the information restoration unit 5 may collect only the distribution unit data required for restoring the original data on the basis of the management information. For example, all the elements of the duplexed original data are distributed and registered in the six storage grids shown in FIG. 7. The three storage grids S3, S4 and S5 of the six storage grids include the all the elements of the original data. As a result, for restoring the original data, the distribution unit information pieces are not required to be collected from all the information registration destinations, and it is sufficient if information is collected from only the three storage grids S3, S4 and S5.

This embodiment has described an example in which the information restoration unit 5 itself communicates with the storage grids for collection of information. However, based on the instructions of the user, the information registration destination decision unit or a management information storing unit may instruct the storage grids storing the information required for restoration of the original data to cause the storage grids to transmit the stored distribution unit information pieces to the information restoration unit 5. The information restoration unit 5 restores the information sent from the storage grids on the basis of the management information.

As described above, it is possible to provide security of information by multiplying, distributing and registering the information.

In particular, from the viewpoint of all the storage grids S, since the vector A corresponding to the original data is distributed after being multiplied, each of the storage grids S stores a plurality of the elements contained in the original data. For this reason, even if some the storage grids S are damaged and the distribution unit information pieces registered in the damaged storage grids are lost, the original data can be restored. This is because the same elements as those contained in the lost distribution unit information piece are contained in another distribution unit information piece. Strictly speaking, when the multiplying of the multiplying number μ is performed, even if {μ−1} distribution unit information pieces are lost, it is possible to reconstruct the original data from the remainder of the distribution unit information pieces.

For example, when the storage grid S1 of the storage grids S1 to S6 shown in FIG. 7 is damaged, the distribution unit information piece d3 will be lost. However, the same elements as those contained in the distribution unit information piece d3 are contained in the distribution unit information piece d6. Since this distribution unit information piece d6 is registered in the storage grid S3, the distribution unit information piece d6 is not lost even if the storage grid S1 is damaged.

Accordingly, the information restoration unit 5 rearranges the distribution unit information pieces collected from the respective storage grids S in the arrangement order, whereby it becomes clear that the same elements as the elements corresponding to blanks due to the lost information are included in other distribution unit information pieces, leading to the restoration of the original data.

In the embodiment, the distribution unit information generation unit 4 and the information restoration unit 5 are provided in the same user terminal 3, so that the user terminal 3 is used to perform the registration and the restoration of information. However, the distribution unit information generation unit 4 and the information restoration unit 5 may not necessarily be provided in the same terminal. For example, the terminal used for registering information may comprise at least the distribution unit information generation unit 4, and the terminal used for reconstructing information may comprise at least the information restoration unit 5.

When the distribution unit information generation unit 4 and the information restoration unit 5 are respectively provided in different terminals as described above, and the information registered by the distribution unit information generation unit 4 is reconstructed in the information restoration unit 5, the information can be transmitted from the distribution unit information generation unit 4 to the information restoration unit 5 without having been stolen.

In addition, the embodiment describes the information registration destination decision unit 2 provided in the management server 1 which is a separate device from the user terminal 3. However, the information registration destination decision unit 2 may be provided in the user terminal 3 and the information registration destinations may be decided in the user terminal 3. However, if the information and registration destinations are decided in the user terminal 3 as described above and management information is generated in the user terminal 3, it is safer to store the management information in a memory or the like which can be disconnected from the user terminal 3.

For reference, when the information registration destination decision unit 2 is provided in the management server 1 which is a separate device from the user terminal 3, this makes it possible to connect a plurality of distribution unit information generation units 4 to a single information registration destination decision unit 2.

Even when the administrator of the management server 1 is not the user of the user terminal 3, original data, distribution unit information pieces and the like are not stolen from the management server 1 because the management server 1 does not have the function of obtaining distribution unit information pieces from the storage grids S.

In addition, when the distribution unit information generation unit 4 is configured to be interconnected to means for encrypting data to encrypt original data and store the encrypted distribution unit information pieces, this makes it possible to ensure the entropy obtained by adding the entropy caused by encryption to the entropy caused by the multiple distribution, resulting in a further improvement in safety in terms of the amount of calculation required.

Furthermore, safety is also assured on the communication path for the management information by interconnecting the information registration destination decision unit 2 to means for encrypting management information for communicating the encrypted management information.

Next, an encryption system illustrated in FIGS. 8 to 14 will be described.

FIG. 8 is a block diagram of an encryption device 6 forming part of the system. The encryption device 6 comprises a data input/output unit 7 (or data I/O unit 7), an encryption unit 8 and a pseudo-random number generation unit 9. The encryption unit 8 has the function of encrypting plaintext supplied from the data I/O unit 7 to generate encrypted text, and the function of outputting the generated encrypted text via the data I/O unit 7.

The pseudo-random number generation unit 9 has the function of generating unpredictable pseudo-random numbers by use of a method described later.

For reference, the plaintext is input and the encrypted text is output through the data I/O unit 7, but, in the embodiment, the data I/O unit 7 corresponds to the plaintext input unit of the present invention.

The encryption unit 8 generates an encryption key on the basis of the pseudo-random numbers generated in the pseudo-random number generation unit 9, and then uses the encryption key to encrypt plaintext.

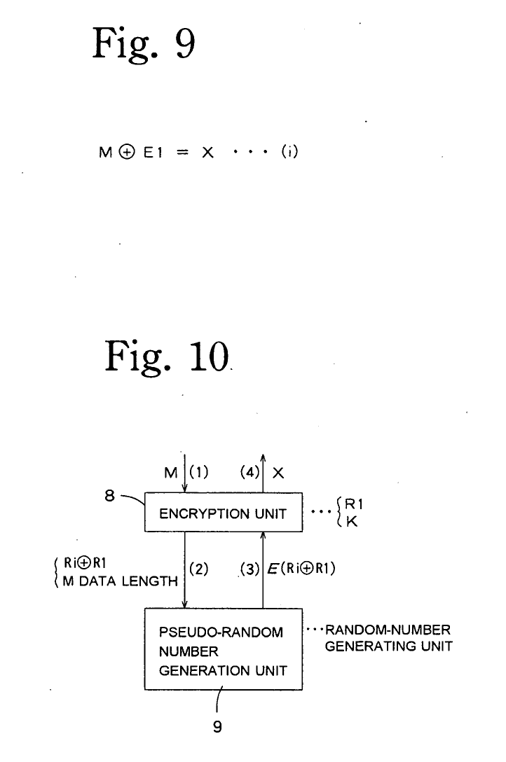

In this example, the vector produced by multiplying the original data is assumed as plaintext M and the encrypted text encrypted using an encryption key E1 is assumed as X. The encryption key E1 is a vector containing pseudo-random numbers and having a data length equal to or greater than the data length of the plaintext M. The encryption unit 8 performs an operation on Equation (i) shown in FIG. 9 to generate a vector which is the vector sum of the encryption key E1 and the plaintext M. This vector is encrypted text X.

Next, a description will be given of the procedure of the encryption unit 8 generating an encryption key E1 to generate encrypted text X, with reference to FIG. 10.

As illustrated in FIG. 10, the encryption unit 8 previously stores a vector R which is the basis of the seed for the pseudo-random numbers, and a vector K which has a data length equal to or greater than that of the plaintext M and has uncertainty which is not lower than the uncertainty of the plaintext M.

Those vectors R1 and K are previously determined and are not required to be changed for each encryption process. The vector R1 is a fixed vector for producing variable seed in the present invention. The vector K is a fixed vector of the present invention for calculating the vector sum with the pseudo-random numbers generated in the pseudo-random number generation unit 9.

The pseudo-random number generation unit 9 previously stores a pseudo-random number generation program for generating pseudo-random numbers using the input seed. The procedure for generating pseudo-random numbers in the pseudo-random number generation program will be described later in detail. In the pseudo-random number generation program, pseudo-random numbers of an arbitrary data length can be generated using seed made up of an arbitrary vector. In the pseudo-random number generation program, when pseudo-random numbers are generated using seed C, the generated pseudo-random numbers are expressed as a function of E(C).

When the plaintext M is encrypted to encrypted text X and then outputted, the data flow in the encryption unit 6 is indicated by the arrows (1) to (4) in FIG. 10.

As indicated by the arrow (1) in FIG. 10, upon input of the plaintext M which is a vector to be encrypted to the encryption unit 8, the encryption unit 8 determines a vector Ri as described below. The vector Ri is a vector individually determined by the encryption unit 8 for each plaintext M, so that it is necessary to determine a different vector Ri every time the encryption process is performed. To achieve this, the encryption unit 8 should be configured to determine the vector Ri by use of, for example, a numeral corresponding to the second, minute, hour and date as of this moment, random numbers generated in a physical random number generator, arbitrary text, data or the like.

After determining the vector Ri, the encryption unit 8 calculates the vector sum [Ri+R1] of the vector Ri and the predetermined fixed vector R1 as illustrated by the course of the arrow (2) in FIG. 10, and then inputs the vector sum as variable seed to the pseudo-random number generation unit 9. In this regard, the above-described sign “+” is taken as representing the vector sum sign, and is used instead of the vector sum sign in equations shown in FIGS. 9, 11, 12, 16 and 17.

That is, the variable seed of the present invention is produced by use of the vector sum [Ri+R1] of a variable vector Ri which is determined for each plaintext M and a fixed vector R1.

In addition, the encryption unit 8 determines the data length of the input plaintext M.

After generating the variable seed as described above and determining the data length of the plaintext M, the encryption unit 8 inputs the generated variable seed and the data length of the plaintext M to the pseudo-random number generation unit 9 (the arrow (2)).

The pseudo-random number generation unit 9 receiving the variable seed and the data length of the plaintext M generates, based on the received variable seed, pseudo-random numbers E(Ri+R1) equal to or greater than the data length of the plaintext M, and then sends them back to the encryption unit 8 as indicated by the arrow (3). The pseudo-random numbers E(Ri+R1) are generated on the basis of the variable seed which is varied in relation to the plaintext M, which are variable pseudo-random numbers of the present invention.

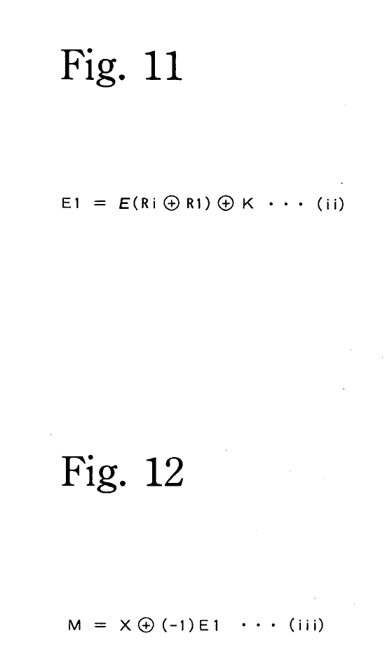

The encryption unit 8 adds the previously stored vector K to the vector of the variable pseudo-random numbers E(Ri+R1) generated by the pseudo-random number generation unit 9 to generate an encryption key E1 as shown in Equation (ii) in FIG. 11. In addition, the encryption unit 8 uses the encryption key E1 to generate encrypted text X in accordance with Equation (i) in FIG. 9 and outputs it (the arrow (4)).

In this regard, the encryption key E1 thus generated can be considered as a vector resulting from substitution of the vector comprising the variable pseudo-random numbers E(Ri+R1) for the fixed vector K of which uncertainty is not lower than the uncertainty of the plaintext M. Accordingly, the uncertainty of the encryption key E1 is not smaller than the uncertainty of the plaintext M. As a result, it is possible to achieve encryption with information logical security. At this stage, the entropy of the encryption key E1 and the entropies of R1, R1, Ri+R1 and E(Ri+R1) are all equal to each other, and E(Ri+R1) can adopt all values in the entropies as a variable.

Note that in the encryption system of the embodiment the vector K is required to have a data length greater than the plaintext M. For encrypting original data having a great data length, the original data is divided into pieces of data each having a data length equal to or less than the data length of the vector K and each piece of the divided data is defined as plaintext M, thus making it possible to achieve encryption in the encryption system. The division of the original data for encryption in divided units eliminates the necessity to determine a vast vector K for encryption of original data having a great data length.

The encryption procedure is performed as described above. An encryption key E1 is required to decrypt the encryption text X thus produced. The encryption key E1 is the vector sum of a variable pseudo-random number vector and the fixed vector K. The variable pseudo-random numbers are pseudo-random numbers which are produced by use of the vector sum of the fixed vector R1 and the variable vector Ri as seed.

In turn, if in the decryption section the pseudo-random number generation unit 9 is also provided and the fixed vector K and the fixed vector R1 are previously set, the encryption key E1 can be produced as in the case of the encryption device 6 by receiving only the vector Ri, which can be changed from one encrypted text X to another, from the encryption device 6. Then the generated encryption key E1 can be used to calculate Equation (iii) in FIG. 12 for the decryption of encrypted text X. In consequence, when encrypted text is transmitted/received, there is no necessity for transmitting/receiving an encryption key E1 which has to be changed for each encryption process. Because the encryption key E1 itself is not transmitted/received, there is no risk of theft of the encryption key E1 on the communication path. Even if an attacker, for example, has intercepted the seed Ri and stolen it, it is impossible for the attacker to determine E1 unless he knows R1 and K.

In addition, even if the variable vector Ri is stolen during communication, the encryption key E1 is not reproduced from the vector Ri, thus ensuring security.

The scheme of generating cipher by use of the vector sum of plaintext and a vector of which uncertainty is not lower than the uncertainty of the plaintext as in the case of this encryption system is characterized in that the encrypted text cannot be information-logically decrypted as proved by Shannon 48, 49 unless the vector T1 and the vector K are leaked. Specifically, pseudo-random numbers which are not smaller than the uncertainty of the plaintext, that is, the encryption key E1, are used for encryption, whereby the uncertainty of the generated encrypted text is equal to or higher than the uncertainty of the plaintext. This encrypted text possesses information-logical security, resulting in the impossibility of decryption. In other words, as long as only the vector R1 and the vector K are not leaked, there is no worry that the encrypted information contents will be stolen by a third party.

Since this encryption system does not have the necessity of transmitting/receiving the encryption key E1 itself even when the encrypted text is transmitted/received through communication means as described above, the encryption key is not stolen during communication. In addition, the fixed vector K which is the basis of the encryption key and the fixed vector R1 which is the basis of the variable pseudo-random number seed are neither of them data required to be transmitted/received each time encryption is processed. Because of this, the risk of the vectors being stolen is significantly low, resulting in little risk that the encryption key E1 will be produced by a third party.

In short, confidential information and the like can be reliably protected by use of this encryption system to encrypt the information.

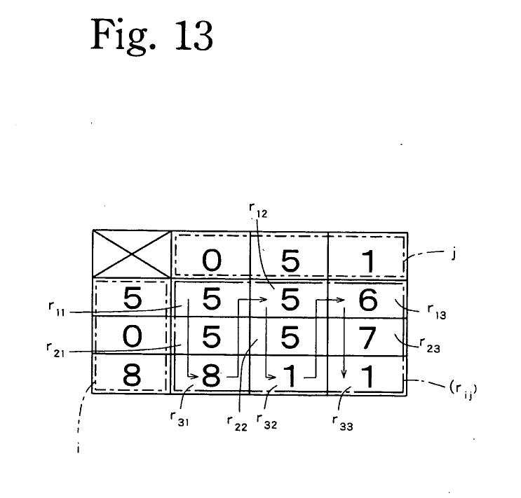

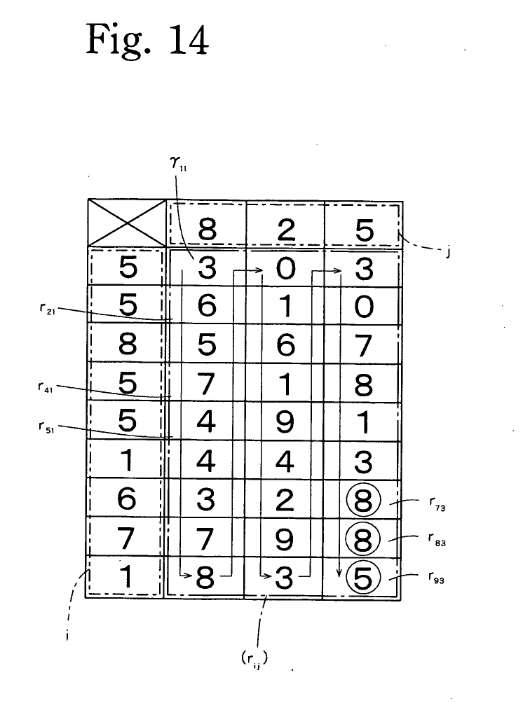

Next, with reference to FIGS. 13 and 14, a description will be given of the procedure of the pseudo-random number generation unit 9 generating pseudo-random numbers expressed in an n-base system based on the pseudo-random number generating program previously stored in the pseudo-random number generation unit 9. For reference, the embodiment describes an example in which the above-described n is equal to 10. However, n is not limited to 10, and may be any value other than zero.

Upon reception of the variable seed generated by use of the vector sum of the vector Ri and the vector R1 and the data length of the plaintext M (see FIG. 10), the pseudo-random number generation unit 9 uses the variable seed to generate pseudo-random numbers which are equal to or greater than the data length of the plaintext M.

Initially, the pseudo-random number generation unit 9 divides the vector of the variable seed, and uses the divided elements as row headers i and column headers j as illustrated in FIG. 13 to make them serve as seeds of pseudo-random numbers, thus creating a calculation table of matrix (rᵢⱼ).

Then, numeric values are assigned in predetermined order to cells of the matrix (rᵢⱼ).

The cell which is the first to be assigned, for example, the cell r₁₁ on the first row and the first column in FIG. 13, is assigned a result of modulo n=10 arithmetic performed on the additional value obtained by adding the value of the column header of the first column relating to the cell r₁₁ and the value of the row header of the first row similarly relating to the cell r₁₁.

Then, each of the cells which are to be assigned except for the cell₁₁ is assigned a result of modulo 10 arithmetic performed on the sum of at least three or more of the values which have already been assigned to the cells or the header cells in the row and the column relating to the cell.

The above-described method will be more concretely described with reference to FIG. 13.

It is assumed in this example that the vector [Ri+R1] which results in the variable seed generated in relation to a certain plaintext M is equal to (0, 5, 1, 5, 0, 8). The vector is divided into two, a first part and a second part. As illustrated in FIG. 13, the row headers i are “5, 0, 8” and the column headers j are “0, 5, 1”, thus creating a matrix with 3 rows and 3 columns.

As described above, after creating the cells of the 3-row by 3-column matrix (rᵢⱼ) with row headers and column headers which are the variable seed, each of the cells is assigned a value obtained by the following calculation.

First, the cell r₁₁ in the first row and the first column is assigned “5” which is the result of modulo 10 arithmetic performed on “5” which is the sum of the “5” of the row header of the first row and the “zero” of the column header of the first column.

Then, another cell other than the cell r₁₁, for example, the cell r₂₁ in the second row and the first column, is given “5” that is a result of modulo 10 arithmetic performed on the sum “5” obtained by adding the “zero” already set as the row header of the second row, the “zero” set as the column header of the first column and the above calculated “5” assigned to the cell r₁₁ in the first column. In this manner, values are assigned, first, to cell r₂₁, then, to cell 131 in the first column, and then the calculation is repeated in order from column to column. Note that the cell r₁₁ corresponds to the first cell of the present invention.

For reference, in the above-described specific example, the cell r₁₁ is defined as the first cell to which a value is assigned, but any cell may be defined as the cell to which the first value is assigned. Any order of assigning values to cells other than the first cell may be selected from various orders. However, it is necessary that at least three or more of the values, which have been already assigned to the cells or set in the header cell in the row or the column relating to a cell to be given a value, are added together, and then modulo 10 arithmetic is preformed on this additional result.

In the example in FIG. 13 the respective values which have been already assigned to a header cell or a cell in the row or the column relating to the cell to be given a value are added together, then modulo 10 arithmetic is performed on the additional result, and then the result of the arithmetic is assigned to the cell.

In this manner, all the cells are filled with values, and then the values are arranged in the order indicated by the arrows in FIG. 12 beginning with the cell 111 so as to generate a nine-digit pseudo-random number vector “5, 5, 8, 5, 5. 1, 6, 7, 1”. For reference, the values in the matrix may be arranged in any order to generate a pseudo-random number vector.

For generating pseudo-random numbers with a large number of digits, a matrix with a large number of cells is created and then the cells are respectively assigned values by the above-mentioned procedure. Then, the values assigned to the respective cells of the matrix are arranged, thus generating pseudo-random numbers with a number of digits by means of a simple method.

In the encryption system, the pseudo-random numbers produced in a 3-row by 3-column matrix form as described above are used as the row headers i and the column headers j to generate pseudo-random numbers with an even larger number of digits. FIG. 14 shows an example of creating a 9-row by 3-column matrix in which 9-digit pseudo-random numbers which have been obtained by the matrix shown in FIG. 13 are assigned to the row header cells i, and another 3-digit vector is assigned to the column header cells j.

By use of the 9-row by 3-column matrix, values are applied to each of the cells of the 9-row by 3-column matrix by following much the same procedure as when the 3-row by 3-column matrix is used. For example, if the obtained values are arranged as indicated by the arrows in FIG. 14, 27-digit pseudo-random numbers can be generated.

Note that, when pseudo-random numbers with less than 27 digits are required, only the required number of values may be arranged in the process of arranging the calculated 27 values. Since the random numbers thus produced mathematically result from a higher dimensional mapping of seed, it can be simply thought that the uncertainty of the random numbers will be equal to the uncertainty of the seed in theory.

For the purpose of generating pseudo-random numbers of a larger number of digits, a 24-row by 3-column matrix is used to generate pseudo-random numbers through the same procedure as the aforementioned one, in which the column headers j are elements of part of the vector containing the pseudo-random numbers generated by use of the matrix shown in FIG. 14 which are, for example, the last three values (8, 8, 5), and the row headers i are the other 24 values. For the purpose of generating pseudo-random numbers of a much larger number of digits, another matrix is used in which the column headers j are part of the pseudo-random numbers generated by use of the above 24-row by 3-column matrix and the row headers are the remainder. Thus, repetition of the procedure as described above makes it possible to generate pseudo-random numbers of any number of digits. That is, by repeating the aforementioned procedure until the number of digits reaches the required number, any desired number of digits of pseudo-random numbers can be obtained. As a result, when the plaintext M has a great data length, the procedure of generating pseudo-random numbers as described is repeated to increase the number of digits of pseudo-random numbers, thus obtaining pseudo-random numbers of a length equal to or longer than the length of the vector of the plaintext M. The uncertainty of the random numbers thus generated is equal to the uncertainty of the seed in theory.

In the foregoing, for generating 27-digit random numbers, the 9-digit pseudo-random numbers generated by use of the 3-row by 3-column matrix are assigned as the row headers and a new vector is assigned as the column headers. Then, for generating pseudo-random numbers greater than the 27-digit random numbers, the pseudo-random numbers which have been already generated are used as row headers and column headers. Alternatively, after the 9-digit pseudo-random numbers have been produced by use of variable seed, the pseudo-random numbers thus generated may be divided for use as the row headers and the column headers. In this connection, if a rule is previously made to assign the last three values as the column headers and the other values as the row headers as in the embodiment, pseudo-random numbers of a large number of digits can be automatically generated. In this manner, the need for preparing a new vector serving as column header during the calculation operation is eliminated.

The foregoing procedures are carried out in accordance with the pseudo-random number generating program previously set in the pseudo-random number generation unit 9, so that the desired pseudo-random numbers are automatically generated.

The pseudo-random numbers thus generated by any one of the aforementioned methods have high uniformity and non-periodicity. This is because, since those pseudo-random numbers are a multiple Markov process and have sensitivity to initial values, it is recognized that the calculation results have ergodicity. In addition, this makes prediction extremely low.

If a value in each cell is set simply as the sum of the two values of a row header and a column header at this stage, this makes it possible to predict the row header and/or the column header from the values in the respective cells.

On the other hand, in the method of generating pseudo-random numbers in this encryption system, since a value or values other than the value of the header is added without exception, prediction is made significantly low. For example, in the matrix (rᵢⱼ) illustrated in FIG. 14, all the row headers of the 1^{st}-row, 1^{st}-column cell r₁₁, the 2^{nd}-row, 1^{st}-column cell r₂₁, the 4^{th}-row, 1^{st}-column cell r₄₁ and the 5^{th}-row, 1^{st}-column cell r₅₁ are “5”, and their column header is “8”. In the case of adding the values of such headers alone, the value “3” is calculated for each of the appropriate cells. However, in the method of the embodiment, the aforementioned cells r₁₁, r₂₁, r₄₁ and r₅₁ are respectively assigned different values as illustrated in FIG. 14. In this manner, the generation of unpredictable pseudo-random numbers is made possible.

When the pseudo-random number vector having a length greater than the plaintext vector is used for encryption as described above, the greater the data length of the plaintext, the larger the number of pseudo-random numbers is required. For this reason, although the required number of pseudo-random numbers is increased as the amount of information of the original data is increased, the generation of non-periodic uniform pseudo-random numbers within a practical time frame is significantly difficulty in the conventional methods.

However, if a system has the function of automatically generating unpredictable pseudo-random numbers such as the aforementioned pseudo-random number generation unit 9, which is configured such that a small number of pseudo-random numbers is generated at the first stage and then the generated pseudo-random numbers are used for the row headers and/or the column headers to generate a larger number of pseudo-random numbers, any large number of pseudo-random numbers can be generated, thus facilitating the generation of an encryption key for encrypting a large amount of plaintext.

Hence, the encryption system of the present invention is configured to generate an encryption key E1 by use of the pseudo-random numbers generated by the pseudo-random number generation 9 in accordance with the aforementioned procedure.

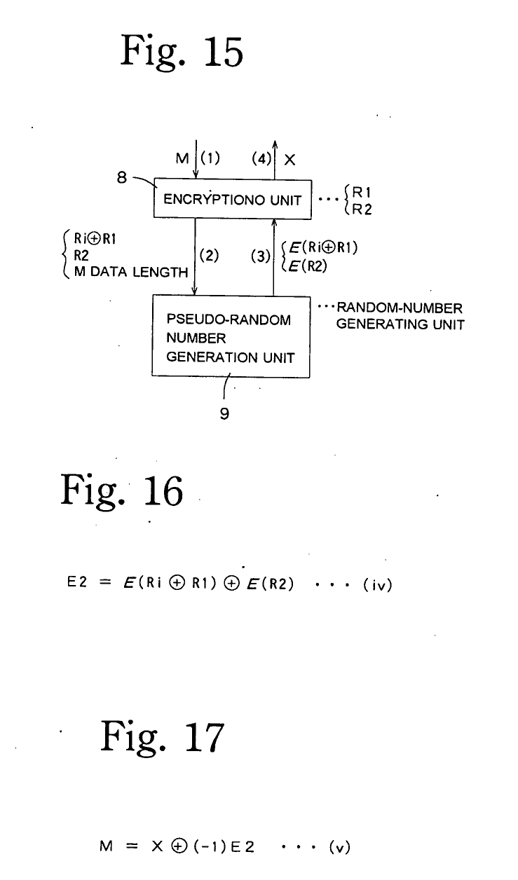

FIGS. 15 to 17 are diagrams illustrating another encryption system operating in accordance with encryption procedure different from that shown in FIG. 10.

The encryption system shown in FIG. 15 also comprises an encryption device 6 as in the case of the system shown in FIG. 8, and the encryption device 6 comprises a data I/O unit 7, an encryption unit 8 and a pseudo-random number generation unit 9. The encryption unit 8 uses the pseudo-random numbers generated by the pseudo-random number generation unit 9 to generate an encryption key E2, then encrypts the plaintext M by use of the encryption key E2, and then outputs the encrypted text X.

Next, a description will be given of the procedure of generating by the encryption unit 8 of an encryption key E2 to generate encrypted text X, with reference to FIG. 15.

As illustrated in FIG. 15, the encryption unit 8 previously stores a fixed vector R1 which is the basis of the seed for pseudo-random numbers, and a vector R2 which is a fixed vector different from the vector R1 and is the basis of the seed for pseudo-random numbers different from the above pseudo-random numbers. The vector R1 and the vector R2 are previously set, and are not required to be changed each time the encryption process is performed. In this regard, it is assumed that the dimension of the vector R1 and the vector R2 is equal to that of the vector Ri.

The pseudo-random number generation unit 9 has previously stored a pseudo-random number generation program for generating pseudo-random numbers by use of the input seed. The procedure of generating pseudo-random numbers in the pseudo-random number generation program is similar to that described with reference to FIGS. 13 and 14. In the pseudo-random number generation program, pseudo-random numbers of an arbitrary data length can be generated using seed which comprises an arbitrary vector. In the pseudo-random number generation program, when pseudo-random numbers are generated using seed C, the generated pseudo-random numbers are expressed as a function of E(C).

As indicated by the arrow (1) in FIG. 15, upon input of the plaintext M which is the vector to be encrypted to the encryption unit 8, the encryption unit 8 determines a vector Ri as described below. The vector Ri is a vector individually determined by the encryption unit 8 for each plaintext M, so that it is required to determine a different vector Ri every time the encryption process is performed. To achieve this, the encryption unit 8 should be configured to determine a vector Ri by use of, for example, a numeral corresponding to the second, minute, hour and date as of this moment, random numbers generated in a physical random number generator, arbitrary text data or the like.

After determining the vector Ri, the encryption unit 8 calculates the vector sum [Ri+R1] of the vector Ri and the predetermined fixed vector R1 as illustrated by the course of the arrow (2) in FIG. 15, and then input the vector sum as variable seed to the pseudo-random number generation unit 9.

That is, the variable seed of the present invention is produced by use of a vector sum [Ri+R1] of a variable vector Ri which is individually determined for each plaintext M and a fixed vector R1.

In addition, the encryption unit 8 determines the data length of the input plaintext M.

After generating the variable seed as described above and determining the data length of the plaintext M, the encryption unit 8 then inputs the variable seed thus generated, the fixed seed made up of the predetermined fixed vector R2, and the data length of the plaintext M to the pseudo-random generation unit 9 (the arrow (2)).

upon reception of the variable seed, the fixed seed made up of the vector R2 and the data length of the plaintext M, the pseudo-random number generation unit 9 generates pseudo-random numbers E(Ri+R1) equal to or greater than the data length of the plaintext M on the basis of the received variable seed. Also, the pseudo-random number generation unit 9 generates pseudo-random numbers E(R2) equal to or greater than the data length of the plaintext M on the basis of the fixed seed made up of the fixed vector R2. Note that the variable pseudo-random numbers E(R2) are generated using the fixed seed, but they are variable pseudo-random numbers generated with a length in accordance with the data length of the plaintext M.

The pseudo-random number generation unit 9 inputs the generated variable pseudo-random numbers E(Ri+R1) and the generated variable pseudo-random numbers E(R2) to the encryption unit 8 (arrow (3)). The encryption unit 8, which has received the two sets of pseudo-random numbers, calculates the vector sum of vectors containing the two sets of pseudo-random numbers as represented in Equation (iv) in FIG. 16, to generate an encryption key E2. Also, the encryption unit 8 calculates a vector sum of the encryption key E2 and the plaintext M to generate encrypted text X, and then outputs the encrypted text X (arrow (4)).

That is, the encryption key E2 used in the encryption system illustrated in FIG. 15 is produced by use of the variable pseudo-random numbers E(R2), instead of the fixed pseudo-random numbers K.

This encryption system is also configured such that the encryption unit 8 generates the encryption key E in accordance with the plaintext M for each encryption process. However, the encryption key E2 can be designed as a variable encryption key for each plaintext M by use of the previously set vectors R1 and R2 and the variable vector Ri determined in accordance with the plaintext M. Since the encryption key E2 is produced by use of the vector sum of two pseudo-random number vectors, the encryption key E2 has approximately twice the entropy as compared with the case of using a single pseudo-random number vector. In this manner, an increase in entropy of the encryption key E2 makes it possible to provide the security in terms of the amount of information.

In addition, as in the case of the encryption key E1 of the aforementioned encryption system, it is possible to prevent leakage in the process of transmitting/receiving the encryption key E2. The information encrypted in this manner can be reliably protected as in the case of the encryption system illustrated in FIG. 10.

The encryption system illustrated in FIG. 15 employs a random number vector using the fixed seed R2, instead of the fixed vector K used in the encryption system described in FIG. 10. For this reason, the data length of the fixed vector R2 previously set in the encryption unit 8 can be reduced as compared with the fixed vector K, resulting in a reduction in load required for storing data.

The reason that the data length of the vector R2 can reduced will be described below. In the encryption system in FIG. 10 the fixed vector K is also required to have a data length equal to or greater than the data length of the plaintext M in order to make the encryption key E1 have a data length equal to or greater than the plaintext M. However, even if the vector R2 which is to be seed for random numbers has a small data length, the pseudo-random number generation 9 is capable of generating a set of random numbers having a data length equal to or greater than that of the plaintext M, which in turn makes it possible to generate an encryption key E2 having a data length equal to or greater than the plaintext M.

In this encryption system the pseudo-random number generation 9 is also capable of automatically generating two types of unpredictable pseudorandom numbers used for generating the encryption key E2.

Note that if the system comprises the pseudo-random number generation unit 9 in which the pseudo-random number generating program is installed, and a decryption unit in which the vectors R1 and R2 are previously set, the decryption unit can generate the encryption key E2 and calculates Equation (v) in FIG. 17 to decrypt the encrypted text X produced in this system.

Even in the case of using either of the aforementioned encryption systems, there is no worry about decryption of the encrypted text, and also the risk of theft of the encryption key is significantly low, thus safely preserving or transmitting secret information or the like.

In the aforementioned systems, the variable seed is generated by use of the vector sum of the variable vector set for each plaintext and the previously set fixed vector. However, the variable seed may be made up of the variable vector alone. In short, what is important is that an encryption key is generated by use of a vector sum of variable pseudo-random numbers in order to generate a variable key in accordance with plaintext.

If the variable seed is generated by use of the vector sum of the variable vector and the fixed vector rather than contains a variable vector alone, the variable vector is substituted for another vector by the fixed vector. For this reason, even if the variable vector is intercepted and leaked an attacker, the security in terms of the amount of calculation for seed is maintained. In addition, the variable seed may be generated by use of a vector sum obtained by adding many vectors together, rather than a vector sum of a variable vector and a fixed vector.

In the embodiments of the aforementioned two encryption system, the encryption key is generated by use of the vector sum of the variable vector and the fixed vector, so as to eliminate the need to transmit/receive the encryption key itself.

However, the encryption key may be made up of a variable vector alone containing pseudo-random numbers generated in accordance with plaintext. The variable vector used in this case is required to be generated by the pseudo-random number generation unit 9 as a pseudo-random number vector having a data length greater than the data length of the plaintext.

It is possible to use the encryption systems to encrypt original data and distribution unit data of the aforementioned information management system, and also to encrypt the management information. In this manner, if information is encrypted by use of the aforementioned encryption system, this improves the security. In this case, the entropy is the sum of obtained by adding the entropy caused by encryption to the entropy caused by the multiple distribution.

What is claimed is:

1. An information management system, comprising:
an information registration destination decision unit that decides registration destinations of information;
a distribution unit information generation unit that generates distribution unit information pieces; and
a plurality of storage grids connectable to the distribution unit information generation unit,
wherein the information registration destination decision unit has
a function of determining the storage grids as registration destinations of the respective distribution unit information pieces generated at the distribution unit information generation unit,
a function of generating management information about correlation between distribution unit information pieces and the storage grids corresponding to the registration destinations of the respective distribution unit information pieces,
a function of notifying the distribution unit information generation unit of the management information generated,
a function of determining a combination of ε number of elements, multiplying number μ and τ number of distributions which fulfills either condition 1 or condition 2, the condition 1 that when a greatest common divisor q of the τ number of distributions and the ε number of elements is one, the relation “the multiplying number μ<τ number of distributions” is established, the condition 2 that when a greatest common divisor q of the τ number of distributions and the ε number of elements is not one, the τ number of distributions and the ε number of elements are indivisible by each other and also the relation “the multiplying number μ≦(τ number of distributions/greatest common divisor q)” is established, and
a function of outputting the combination of ε number of elements, multiplying number μ and τ number of distributions thus determined, and
the distribution unit information generation unit has
a function of dividing original data with reference to either a predetermined unit data length or a predetermined dividing number to obtain a vector A=(a₁, a₂, . . . , a_{ε}) containing N [symbol] ε elements,
a function of multiplying the vector A by a factor of μ to obtain a vector μA=(A₁∥A₂∥ . . . ∥A_{μ}), wherein A=A₁=A₂= . . . =A_{μ}, on the basis of either multiplying number μεN input to the distribution unit information generation unit or predetermined multiplying number μεN,
a function of dividing all the elements of the vector μA thus multiplied into τ number of the distribution unit information pieces on the basis of either τ number of distribution εN applied to the distribution unit information generation unit or predetermined τ number of distribution εN, such that all the elements of the vector A are not included and the same element in the vector A does not occur in each divided group of the elements twice or more, and
a function of registering the distribution unit information pieces to the corresponding storage girds on the basis of the management information defining the correlation between the distribution unit information pieces and the storage grids received from the information registration destination decision unit.

2. The information management system according to claim 1, wherein the distribution unit information generation unit has a function of repeating, in either a column direction or a row direction, a process of arranging all the elements of the vector obtained by multiplying original data by the multiplying number μ in element order either in the row direction or the column direction, to form a matrix with the number of either columns or rows in accordance with the τ number of distributions and a required number of either rows or columns, and a function of defining either each of the columns or each of the rows of the matrix as a single distribution unit information piece.

3. The information management system according to claim 1 or 2, further comprising:
either the information registration destination decision unit or a separate management information storing unit from the information registration destination decision unit for storing the management information; and
an information restoration unit restoring the distribution unit information pieces to the original data,
wherein the information restoration unit has a function of collecting the distribution unit information pieces from the respective storage grids, a function of acquiring the management information, and a function of arranging the collected distribution unit information pieces on the basis of an arrangement order determined from the management information.

4. The information management system according to any one of claims 1 to 3, further comprising an encryption unit interconnected to the distribution unit information generation unit,
wherein the encryption unit has a function of encrypting original data, and the distribution unit information generation unit has a function of multiplying the data encrypted by the encryption unit with multiplying number μ.

5. An encryption system, comprising:
a plaintext input unit;
an encryption unit; and
a pseudo-random number generation unit,
wherein the pseudo-random number generation unit generates pseudo-random numbers by performing
a function of dividing seed for generating pseudo-random numbers into elements in units of predetermined information amount,
a function of generating a matrix using the elements as row headers and column headers,
a function of defining a specific cell in the matrix as a first cell and assigning, to the first cell, a result of modulo n arithmetic, where n is a predetermined value other than zero, performed on a result of addition of values of the row header and the column header relating to the first cell together,
a function of for each of the cells other than the first cell in the matrix, adding at least three or more values of the values assigned to the corresponding row and column together in order to form multiple Markov process, then performing modulo n (n=other than zero) arithmetic, and then assigning a result of the modulo n arithmetic to the cell, and
a function of rearranging the values assigned to the respective cells in either column order or row order on either column-by-column basis or row-by-row basis, and
the pseudo-random number generation unit generates pseudo-random numbers by performing
a function of outputting the pseudo-random numbers to the encryption unit when the pseudo-random numbers has a data length greater than the data length of the plaintext, and of generating a matrix by use of either part of or all the elements of the generated pseudo-random numbers as either row headers or column headers, or both of the row headers and the column headers when the pseudo-random numbers has a data length less than the data length of the plaintext,
a function of defining a specific cell in the matrix as a first cell and assigning, to the first cell, a result of modulo n arithmetic, where n is a predetermined value other than zero, performed on a result of addition of values of the row header and the column header relating to the first cell together,
a function of, for each of the cells other than the first cell in the matrix, adding at least three or more values of the values assigned to the corresponding row and column together, then performing modulo n (other than zero) arithmetic on the added value, and then assigning a result of the modulo n arithmetic to the cell, and
a function of rearranging the values assigned to the respective cells in either column order or row order on either column-by-column basis or row-by-row basis, and
the pseudo-random number generation unit repeatedly performs the pseudo-random number generating function until the generated pseudo exceeds the data length of the plaintext, and then when the pseudo-random number greater than the data length of the plaintext is generated, this pseudo-random numbers are output to the encryption unit, and
the encryption unit uses a vector of the pseudo-random numbers supplied from the pseudo-random number generation unit as an encryption key to calculate a vector sum of the plaintext and the encryption key for encryption.

6. An encryption system, comprising:
a plaintext input unit;
an encryption unit; and
a pseudo-random number generation unit,
wherein the pseudo-random number generation unit generates pseudo-random numbers by performing
a function of dividing seed for generating pseudo-random numbers into elements in units of predetermined information amount,
a function of generating a calculation table (hereinafter referred to as “matrix”) using the elements as row headers and column headers,
a function of defining a specific cell in the matrix as a first cell and assigning, to the first cell, a result of modulo n arithmetic, where n is a predetermined value other than zero, performed on a result of addition of values of the row header and the column header relating to the first cell together,
a function of, for each of the cells other than the first cell in the matrix, adding at least three or more values of the values assigned to the corresponding row and column together in order to form multiple Markov process, then performing modulo n (other than zero) arithmetic, and then assigning a result of the modulo n arithmetic to the cell, and
a function of rearranging the values assigned to the respective cells in either column order or row order on either column-by-column basis or row-by-row basis, and
the pseudo-random number generation unit generates pseudo-random numbers by performing
a function of outputting the pseudo-random numbers to the encryption unit when the pseudo-random numbers has a data length greater than the data length of the plaintext, and of generating a matrix by use of either part of or all the elements of the generated pseudo-random numbers as either row headers or column headers, or both of the row headers and the column headers when the pseudo-random numbers has a data length less than the data length of the plaintext,
a function of defining a specific cell in the matrix as a first cell and assigning, to the first cell, a result of modulo predetermined n arithmetic, where n is a predetermined value other than zero, performed on a result of addition of values of the row header and the column header relating to the first cell together,
a function of, for each of the cells other than the first cell in the matrix, adding at least three or more values of the values assigned to the corresponding row and column together, then performing the modulo n arithmetic on the added value, and then assigning a result of the modulo n arithmetic to the cell, and
a function of rearranging the values assigned to the respective cells in either column order or row order on either column-by-column basis or row-by-row basis, and
the pseudo-random number generation unit has a function of repeatedly performing the pseudo-random number generating function until the generated pseudo exceeds the data length of the plaintext, and then outputting the pseudo-random numbers to the encryption unit when the pseudo-random number greater than the data length of the plaintext is generated, and
the encryption unit has a function of calculating a vector sum of a vector of the generated variable pseudo-random numbers and a predetermined fixed vector to generate an encryption key, and a function of calculating a vector sum of the generated encryption key and the plaintext for encryption.

7. An encryption system, comprising:
a plaintext input unit;
an encryption unit; and
a pseudo-random number generation unit,
wherein the pseudo-random number generation unit generates pseudo-random numbers by performing
a function of dividing seed for generating pseudo-random numbers into elements in units of predetermined information amount,
a function of generating a calculation table (hereinafter referred to as “matrix”) using the elements for row headers and column headers,
a function of defining a specific cell in the matrix as a first cell and assigning, to the first cell, a result of modulo predetermined n arithmetic, where n is a predetermined value other than zero, performed on a result of addition of values of the row header and the column header relating to the first cell together,
a function of, for each of the cells other than the first cell in the matrix, adding at least three or more values of the values assigned to the corresponding row and column together in order to form multiple Markov process, then performing modulo n (other than zero) arithmetic and then assigning a result of the modulo n arithmetic to the cell, and
a function of rearranging the values assigned to the respective cells in either column order or row order on either column-by-column basis or row-by-row basis, and
the pseudo-random number generation unit generates pseudo-random numbers by performing
a function of outputting the pseudo-random numbers to the encryption unit when the pseudo-random numbers has a data length greater than the data length of the plaintext, and of generating a matrix by use of either part of or all the elements of the generated pseudo-random numbers as either row headers or column headers, or both of the row headers and the column headers when the pseudo-random numbers has a data length less than the data length of the plaintext,
a function of defining a specific cell in the matrix as a first cell and assigning, to the first cell, a result of modulo predetermined n (other than zero) arithmetic performed on a result of addition of values of the row header and the column header corresponding the first cell together,
a function of, for each of the cells other than the first cell in the matrix, adding at least three or more values of the values assigned to the corresponding row and column together, then performing the modulo n arithmetic on the added value, and then assigning a result of the modulo n arithmetic to the cell, and
a function of rearranging the values assigned to the respective cells in either column order or row order on either column-by-column basis or row-by-row basis, and
the pseudo-random number generation unit has
a function of repeatedly performing the pseudo-random number generating function until the generated pseudo-random numbers exceed the data length of the plaintext, and then outputting the pseudo-random numbers to the encryption unit when the pseudo-random number greater than the data length of the plaintext is generated, and
a function of using predetermined fixed seed to generate variable pseudo-random numbers having a data length greater than the data length of the plaintext, and outputting the variable pseudo-random numbers to the encryption unit, and
the encryption unit has a function of calculating a vector sum of two sets of the generated variable pseudo-random numbers to generate an encryption key, and a function of calculating a vector sum of the generated encryption key and the plaintext for encryption.
